(19) United States
(12) Patent Application Publication
(10) Pub. No.: US 2011/0050690 A1
(43) Pub. Date: Mar. 3, 2011

(54) Apparatus and method of transforming 3D object

(75) Inventor: Tae Hyun Rhee, Yongin-si (KR)

(73) Assignee: SAMSUNG ELECTRONICS CO., LTD., Suwon-si (KR)

(21) Appl. No.: 12/662,658

(22) Filed: Apr. 27, 2010

(30) Foreign Application Priority Data
Sep. 1, 2009 (KR) 10-2009-0081907

(51) Int. Cl. G06T 15/70

(52) U.S. Cl. 345/420

(57) ABSTRACT

Provided are a three-dimensional (3D) object transformation apparatus and a method using the same, that may transform the 3D object to obtain animation effects. When transforming the 3D object, coordinates of a vertex constituting the 3D object may be controlled to naturally transform the 3D object.

### CROSS-REFERENCE TO RELATED APPLICATIONS

This application claims the priority benefit of Korean Patent Application No. 10-2009-0081907, filed on Sep. 1, 2009, in the Korean Intellectual Property Office, the disclosures of which are incorporated herein by reference.

### BACKGROUND

1. Field

Exemplary embodiments relate to a three-dimensional (3D) computer animation.

2. Description of the Related Art

An application field of computer animation used in games, movies, and the like is gradually expanding. Also, unlike prior three-dimensional (3D) computer animation that may simply express only objects and backgrounds, a current 3D computer animation may provide various representations concerning people. Particularly, due to the emergence of a digital actor, techniques for more naturally moving human facial expressions and body may be desired.

In the 3D computer animation, both a man and an object may be expressed as a 3D object comprised of polygons. Also, the polygons constituting the 3D object may be comprised of a plurality of vertexes. In the 3D computer animation, a location of each of the plurality of vertexes may need to be transformed at a specific point in time, so that a movement of the 3D object appears to be made in a similar manner as in an actual object.

A human face may be a part of a human body that may be most sensitively recognized, and thus may still be readily recognized with a relatively minute error in comparison with other parts. Accordingly, a facial expression animation may be known as one of a most difficult animation application.

### SUMMARY

According to an aspect of exemplary embodiments, there is provided a three-dimensional (3D) object transformation apparatus, including: a surface distance computing unit to compute a surface distance between a first vertex and a second vertex comprised of a 3D object at a first point in time; and an object transformation unit to transform coordinates of the first vertex at a second point in time based on the computed surface distance using at least one processor.

According to another aspect of exemplary embodiments, there is provided a 3D object transformation method, including: computing a surface distance between a first vertex and a second vertex comprised of a 3D object at a first point in time; and transforming coordinates of the first vertex at a second point in time based on the computed surface distance, wherein the method may be performed using at least one processor.

According to exemplary embodiments, it is possible to naturally display movements of a 3D character in a 3D game, a virtual reality, and the like.

According to another aspect of exemplary embodiments, there is provided at least one computer readable recording medium storing computer readable instructions to implement methods of the disclosure.

Additional aspects of exemplary embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of exemplary embodiments, taken in conjunction with the accompanying drawings of which:

FIG. 1 is a diagram used for describing a concept of transformation of a three-dimensional (3D) object according to exemplary embodiments;

FIGS. 2A and 2B are diagrams used for describing a concept of a surface distance of a 3D object according to exemplary embodiments;

FIG. 3 is a block diagram illustrating a structure of a 3D object transformation apparatus according to exemplary embodiments;

FIG. 4 is a diagram used for describing effects of a 3D object transformation technique according to exemplary embodiments; and

FIG. 5 is a flowchart illustrating a 3D object transformation method according to exemplary embodiments.

### DETAILED DESCRIPTION

Reference will now be made in detail to exemplary embodiments, examples of which are illustrated in the accompanying drawings, wherein like reference numerals refer to the like elements throughout. Exemplary embodiments are described below to explain the present disclosure by referring to the figures.

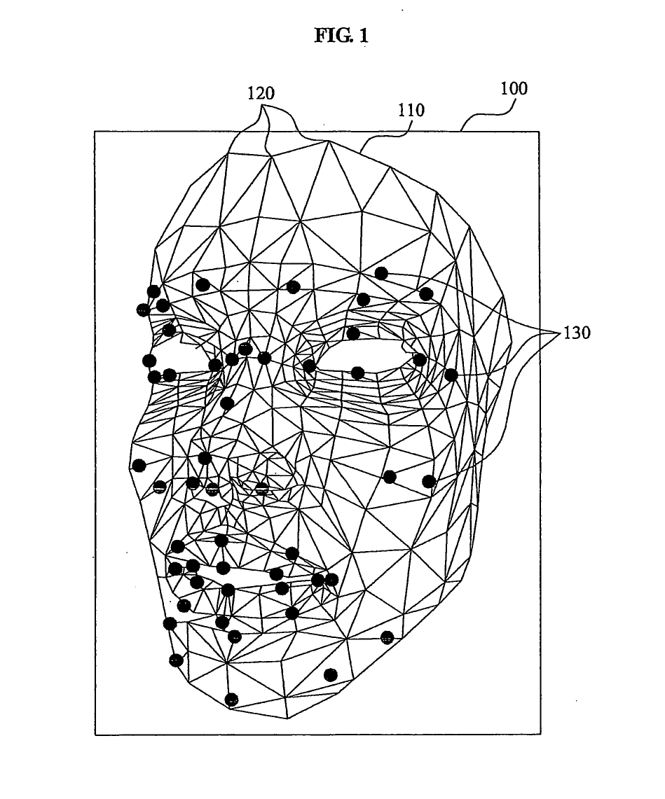

FIG. 1 is a diagram used for describing a concept of transformation of a three-dimensional (3D) object according to exemplary embodiments.

In FIG. 1, a human face is illustrated as a 3D object 100, however, according to other exemplary embodiments, it may be possible to illustrate a 3D object expressing an object, an animal, and the like as well as other parts of a human body.

A plurality of lines 110 and a plurality of vertexes 120 may be composed of a polygon, and a plurality of polygons may be composed of a 3D object. Accordingly, to express movements of the 3D object, each of the plurality of polygons may be transformed, or coordinates of each of the plurality of vertexes 120 constituting the polygon may be transformed.

That is, transforming of the 3D object 100 to have similar movements as those of an actual object may be transforming of the coordinates of each of the plurality of vertexes 120 constituting the 3D object.

As illustrated in FIG. 1, the human face may be a part of a human body that may be most sensitively recognized, and thus may be significantly recognized by a relatively minute error in comparison with other parts. Accordingly, facial expression animation may be known as one of a most difficult animation application.

According to an exemplary embodiment, a 3D object transformation apparatus may precisely transform coordinates of a control point 130, indicating characteristics of the human face among the plurality of vertexes, to thereby control basic facial expressions. These control points may be vertexes indicating locations of eyes, a nose, lips, and the like of the human face. The 3D object transformation apparatus may smoothly transform a full face shape based on the locations of the control points to thereby express a face animation.

For example, when desiring to express a smiling face, the 3D object transformation apparatus may transform coordinates of control points expressing a contour of the lips, so that lateral sides of the lips may be raised. The 3D object transformation apparatus may transform coordinates of other vertexes expressing remaining parts of the lips, so that the coordinates of the other vertexes may be well matched with the coordinates of the control points.

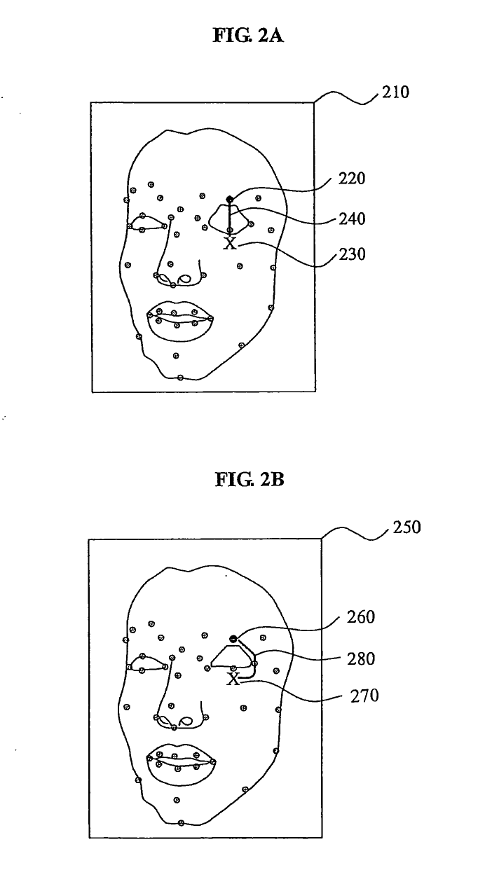

FIGS. 2A and 2B are diagrams 210 and 250 used for describing a concept of a surface distance of a 3D object according to exemplary embodiments. The 3D object may be comprised of first vertexes and second vertexes. The first vertexes may be general vertexes constituting the 3D object, however, the second vertexes may be control points indicating characteristics of the 3D object. In FIGS. 2A and 2B, the first vertexes are not illustrated, however, the second vertexes are illustrated as shaded in points.

Each of vertexes constituting the 3D object may have 3D coordinates, and thus may be expressed as a vector type. Since a distance between two vectors may be generally defined using a Euclidean distance, a distance between two vertexes may be also defined by the Euclidean distance. The Euclidean distance may designate the shortest distance between two vertexes.

However, when transforming the 3D object based on the Euclidean distance between two vertexes, the 3D object may be unnaturally transformed.

In FIG. 2A, the Euclidean distance between two vertexes constituting the 3D object is illustrated. A first vertex 220 of the two vertexes constituting the 3D object may be located above the eyes, and a second vertex 230 constituting the 3D object may be located below the eyes. A Euclidean distance 240 may be a straight line between the two vertexes 220 and 230.

That is, a space between the two vertexes 220 and 230 may be a part excluding the 3D object expressing the human face.

In FIG. 2B, a distance on an outer surface of the 3D object between the two vertexes constituting the 3D object is illustrated.

The distance on the outer surface of the 3D object may be a distance 280 along a curved line around the eyes, which is different from a straight distance 240 between the two vertexes 260 and 270. The outer surface of the 3D object may be expressed as complex curved lines along curvatures of the human body. Accordingly, a method of accurately computing the distance on the outer surface of the 3D object may require a large quantity of computation, and may encounter difficulties in a real-time process.

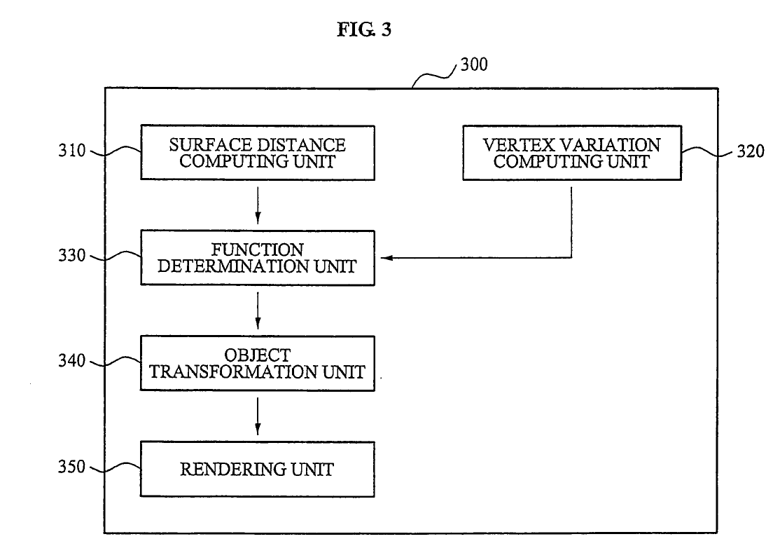

FIG. 3 is a block diagram 300 illustrating a structure of a 3D object transformation apparatus according to exemplary embodiments.

A surface distance computing unit 310 may compute a distance on the outer surface of the 3D object between the first and second vertexes constituting the 3D object, at a first point in time. The first vertex may be a general vertex constituting the 3D object, however, the second vertex may be a control point indicating characteristics of the 3D object. Hereinafter, the distance on the outer surface of the 3D object may be simply referred to as a surface distance. The first vertex and the second vertex may be located on the outer surface of the 3D object. In this case, the surface distance may be formed along a curved line located on the outer surface of the 3D object while connecting the first vertex and the second vertex.

The surface distance computing unit 310 may compute the surface distance between the first vertex and the second vertex on the outer surface of the 3D object using complex functions expressing the outer surface of the 3D object. According to an exemplary embodiment, the surface distance 310 may accurately compute the surface distance in non real-time using complex functions.

The surface distance computed by the surface distance computing unit 310 may be a surface distance with respect to the 3D object at the first point in time. The first point in time may be a point in time of t=0. Since the surface distance computing unit 310 computes the surface distance with respect to the 3D object at the point in time of t=0, that is, before performing a transformation of the 3D object, the surface distance may be accurately computed while reducing a quantity of computation.

An object transformation unit 340 may transform coordinates of the first vertex at a second point in time based on the surface distance between the first vertex at the first point in time and the second vertex at the first point in time.

When the coordinates of the first vertex is changed, a shape of the 3D object may be changed, or a location of the 3D object may be moved.

According to an exemplary embodiment, the 3D object may be comprised of a plurality of first vertexes and at least one second vertex. In this case, the surface distance computing unit may compute a surface distance matrix including a surface distance between each of the plurality of first vertexes and each of the at least one second vertex.

When it is assumed that the surface distance matrix is G, a surface distance between an i-th first vertex and a j-th second vertex may be an element of an i-th row and j-th column of G. The object transformation unit 340 may transform coordinates of the first vertex based on the surface distance matrix.

The vertex variation computing unit 320 may compute a coordinate-difference between coordinates of the second vertex at the first point in time and coordinates of the second vertex at the second point in time. Also, when it is assumed that a point in time of t=0 is the first point in time, the second point in time may be a point in time of t=t₁. Here, t₁ may be an arbitrary positive number greater than zero. That is, the second point in time may be a point in time when the transformation of the 3D object is performed after the first point in time.

The coordinate-difference of the second vertex may be a change amount of the coordinates from the first point in time and the second point in time.

By animation effects, coordinates of the second vertexes at the second point in time may be determined. That is, when the 3D object indicates a human face, the coordinates of the second vertexes, having a great influence on facial expressions, may be determined depending on the facial expressions at the second point in time.

The vertex variation computing unit 320 may compare coordinates of the second vertex at the first point in time with coordinates of the second vertex at the second point in time to thereby compute the coordinate-difference of the second vertex. Since the coordinate-difference only with respect to the second vertex, which is different from all vertexes constituting the 3D object, is computed, the vertex variation computing unit 320 may compute the coordinate-difference of the second vertex in real time. According to an exemplary embodiment, the vertex variation computing unit 320 may compute the coordinate-difference of the second vertex using the Euclidean distance.

The object transformation unit 340 may transform coordinates of the first vertex at the second point in time based on a surface distance between the first vertex at the first point in time and the second vertex at the first point in time. According to an exemplary embodiment, the object transformation unit 340 may compute coordinates of the second vertex at the second point in time based on the coordinates of the second vertex at the first point in time and based on the coordinate-difference of the second vertex, and may change the coordinates of the first vertex at the second point in time based on the computed coordinates of the second vertex at the second point in time.

The object transformation unit 340 may transform the coordinates of the first vertex at the second point in time based on a surface distance at the first point in time. Since the surface distance is expressed as a complex equation, it may be very difficult to compute the surface distance in real-time. Since the surface distance at the first point in time is a fixed value, the object transformation unit 340 may compute the surface distance at the first point in time at a single time, and may iteratively use the surface distance at the first point in time in order to transform the coordinates of the first vertex at the second point in time after the first point in time.

Accordingly, the object transformation unit 340 may transform the coordinates of the first coordinates at the second point in time in real time.

A function determination unit 330 may determine a vertex-coordinate transformation function based on the coordinate-difference of the second vertex and based on the surface distance of the 3D object of the first vertex. When the 3D object is comprised of a plurality of second vertexes, influences of which each of the plurality of second vertexes exerts on each of the first vertexes may be different from one another. In this case, the vertex-coordinate transformation function may be determined based on a weight with respect to the second vertex.

The object transformation unit 340 may transform the coordinates of the first vertex based on the vertex-coordinate transformation function.

According to an exemplary embodiment, a vertex-coordinate transformation function of R^{t}(v) may be determined by

$${R}^{t} ( v ) = P ( v ) + {\sum }_{i = 1}^{m} {λ}_{i}^{t} \cdot φ ( G ( v , {c}_{i}^{0} ) ) , \qquad [ Equation 1 ]$$

where v represents a set of the first vertexes constituting the 3D object, P(v) represents a low-degree polynomial, λᵢ represents a weight value with respect to an i-th second vertex, and φ(x) represents a basis function with respect to a variable. As an example of the basis function, a Gaussian function may be used. G(v,cᵢ⁰) represents a surface distance matrix.

The rendering unit 350 may render the 3D object of which the coordinates of the first vertex is transformed. The rendering unit 350 may render the 3D object based on a material of the 3D object, a direction of a light source, and the like.

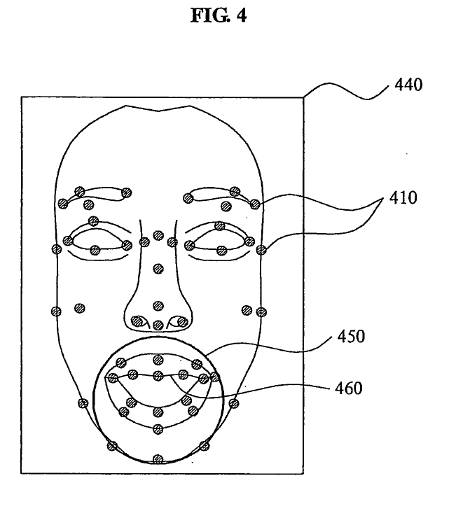

FIG. 4 is a diagram 440 used for describing effects of a 3D object transformation technique according to exemplary embodiments. In FIG. 4, the 3D object comprised of a plurality of first vertexes and a plurality of second vertexes is illustrated. In FIG. 4, each of the plurality of first vertexes is not illustrated, however, the plurality of second vertexes are illustrated as shaded in points 410.

When using the surface distance, a distance between the first vertex and the second vertex may be defined as a distance on the outer surface of the 3D object. Referring to FIG. 2B, a surface distance between the first vertex 260 located above an eye and the second vertex 230 location below the eye may be a distance along a curved line around the eye.

When using the surface distance, the 3D object may be naturally transformed. Close observation in a vicinity 450 of lips 460 of the transformed 3D object reveals a smooth curve line is illustrated to form the lips 460.

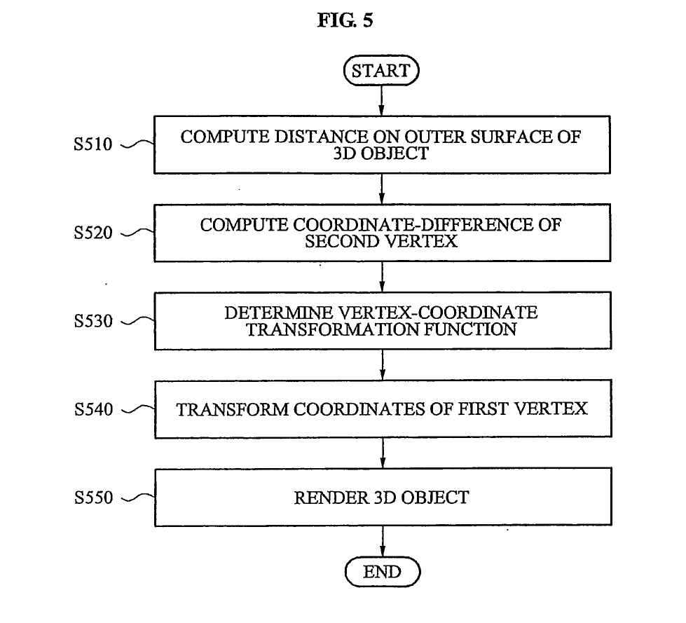

FIG. 5 is a flowchart illustrating a 3D object transformation method according to exemplary embodiments.

In operation S510, the 3D object transformation apparatus may compute a surface distance between a first vertex constituting the 3D object at a first point in time with a second vertex constituting the 3D object at the first point in time. The surface distance may be defined as a distance on an outer distance of the 3D object.

The first vertex and the second vertex may be located on the outer surface of the 3D object. In this case, the surface distance may be formed along a curved line located on the outer surface of the 3D object while connecting the first vertex and the second vertex.

The first vertex may be a general vertex constituting the 3D object, however, the second vertex may be a control point indicating characteristics of the 3D object.

By animation effects, coordinates of the second vertexes at the second point in time may be determined. That is, when the 3D object indicates a human face, the coordinates of the second vertexes, having a great influence on facial expressions, may be determined depending on the facial expressions at the second point in time.

According to an exemplary embodiment, the 3D object may be comprised of a plurality of first vertexes and at least one second vertex. In this case, in operation S510, the 3D object transformation apparatus may compute a surface distance matrix including a surface distance between each of the plurality of first vertexes and each of the at least one second vertex.

When it is assumed that the surface distance is G, a surface distance between an i-th first vertex and a j-th second vertex may be an element of an i-th row and j-th column of G.

In operation S520, the 3D object transformation apparatus may compute a coordinate-difference between coordinates of the second vertex at the first point in time and coordinates of the second vertex at the second point in time.

In operation S530, the 3D object transformation apparatus may determine a vertex-coordinate transformation function. According to an exemplary embodiment, the 3D object transformation apparatus may determine the vertex-coordinate transformation function based on at least one of the coordinate-difference between the second vertexes at the first point in time and the second point in time and the surface distance between the coordinates of the second vertex at the first point in time and the coordinates of the first vertex at the first point in time.

When a 3D object is comprised of a plurality of second vertexes, influences of which each of the plurality of second vertexes exerts on each of the first vertexes may be different from one another. In this case, the vertex-coordinate transformation function may be determined based on a weight with respect to the second vertex.

In operation S540, the 3D object transformation apparatus may transform the coordinates of the first vertex to determine the coordinates of the first vertex at the second point in time. According to an exemplary embodiment, in operation S540, the 3D object transformation apparatus may determine the coordinates of the second vertex at the second point in time based on the surface distance between the first vertex and the second vertex at the first point in time.

When the 3D object is comprised of a plurality of first vertexes and at least one second vertex, the 3D object transformation apparatus may transform the coordinates of the first vertex based on a surface distance matrix including information about the surface distance between respective vertexes. Since the coordinates of the first vertex is transformed based on influences of at least one second vertex with respect to the first vertex into account, the coordinates of the first vertex may be accurately transformed.

Also, the 3D object transformation apparatus may transform the coordinates of the first vertex based on the coordinates of the second vertex at the first point in time and based on the coordinate-difference between the coordinates of the second vertex at the first point in time and the coordinates of the second vertex at the second point in time.

In operation S550, the 3D object transformation apparatus may render the 3D object of which the coordinates of the first vertex is transformed. The 3D object transformation apparatus may render the 3D object based on a material of the 3D object, a direction of a light source, and the like.

The above described methods may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The computer-readable media may also be a distributed network, so that the program instructions are stored and executed in a distributed fashion. The program instructions may be executed by one or more processors. The computer-readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

Although a few exemplary embodiments have been shown and described, it would be appreciated by those skilled in the art that changes may be made in these exemplary embodiments without departing from the principles and spirit of the disclosure, the scope of which is defined in the claims and their equivalents.

What is claimed is:

1. A three-dimensional (3D) object transformation apparatus, comprising:
a surface distance computing unit to compute a surface distance between a first vertex and a second vertex comprised of a 3D object at a first point in time; and
an object transformation unit to transform coordinates of the first vertex at a second point in time based on the computed surface distance using at least one processor.

2. The 3D object transformation apparatus of claim 1, wherein the surface distance is a distance between the first vertex and the second vertex, each located on an outer surface of the 3D object.

3. The 3D object transformation apparatus of claim 1, further comprising:
a vertex variation computing unit to compute a coordinate-difference between coordinates of the second vertex at the first point in time and coordinates of the second vertex at the second point in time,
wherein the object transformation unit transforms the coordinates of the first vertex based on the coordinate-difference.

4. The 3D object transformation apparatus of claim 3, wherein the object transformation unit transforms the coordinates of the first vertex based on the coordinates of the second vertex at the first point in time.

5. The 3D object transformation apparatus of claim 3, further comprising:
a function determination unit to determine a vertex-coordinate transformation function based on the coordinate-difference and the surface distance,
wherein the object transformation unit transforms the coordinates of the first vertex based on the vertex-coordinate transformation function.

6. The 3D object transformation apparatus of claim 5, wherein a number of the second vertexes is two or more, and the vertex-coordinate transformation function is determined based on a weight with respect to each of the second vertexes.

7. The 3D object transformation apparatus of claim 1, further comprising a rendering unit to render the 3D object of which the coordinates of the first vertex is transformed.

8. The 3D object transformation apparatus of claim 1, wherein a number of the first vertexes is two or more, the surface distance computing unit computes a surface distance matrix including the surface distance between the first vertex and the second vertex, and the object transformation unit transforms the coordinates of each of the first vertexes based on the surface distance matrix.

9. A 3D object transformation method, comprising:
computing a surface distance between a first vertex and a second vertex comprised of a three dimensional (3D) object at a first point in time; and
transforming coordinates of the first vertex at a second point in time based on the computed surface distance,
wherein the method is performed using at least one processor.

10. The 3D object transformation method of claim 9, wherein the surface distance is a distance between the first vertex and the second vertex, each located on an outer surface of the 3D object.

11. The 3D object transformation method of claim 9, further comprising:
computing a coordinate-difference between coordinates of the second vertex at the first point in time and coordinates of the second vertex at the second point in time,
wherein the transforming of the coordinates of the first vertex transforms the coordinates of the first vertex based on the coordinate-difference.

12. The 3D object transformation method of claim 11, wherein the transforming of the coordinates of the first vertex transforms the coordinates of the first vertex based on the coordinates of the second vertex at the first point in time.

13. The 3D object transformation method of claim 11, further comprising:
determining a vertex-coordinate transformation function based on the coordinate-difference and the surface distance,
wherein the transforming of the coordinates of the first vertex transforms the coordinates of the first vertex based on the vertex-coordinate transformation function.

14. The 3D object transformation method of claim 13, wherein a number of the second vertexes is two or more, and the vertex-coordinate transformation function is determined based on a weight with respect to each of the second vertexes.

15. The 3D object transformation method of claim 9, further comprising rendering the 3D object of which the coordinates of the first vertex is transformed.

16. The 3D object transformation method of claim 9, wherein a number of the first vertexes is two or more, the computing of the surface distance computes a surface distance matrix including the surface distance between the first vertex and the second vertex, and the transforming of the coordinates of the first vertex transforms the coordinates of each of the first vertexes based on the surface distance matrix.

17. At least one computer readable medium storing computer readable instructions that control at least one processor to implement the method of claim 9.
